(19) United States
(12) Patent Application Publication
(10) Pub. No.: US 2022/0092878 A1
(43) Pub. Date: Mar. 24, 2022

(54) METHOD AND APPARATUS FOR DOCUMENT MANAGEMENT

(71) Applicant: Samsung Electronics Co., Ltd., Suwon-si (KR)

(72) Inventors: Bokul BORAH, Noida (IN); Prachi GUPTA, Noida (IN); Shalab SHALAB, Noida (IN); Ayushi GUPTA, Noida (IN); Theophilus THOMAS, Noida (IN); Sumit Kumar TIWARY, Noida (IN); Bindu Madhavi MISHRA, Noida (IN); Dalbir Singh DHILLON, Noida (IN); Manoj KUMAR, Noida (IN); Santosh Pallav SAHU, Noida (IN); Shweta GARG, Noida (IN); Sourav CHATTERJEE, Noida (IN); Tasleem ARIF, Noida (IN); Naresh Kumar GUPTA, Noida (IN); Pooja PAWWAR, Noida (IN); Vipin TIWARI, Noida (IN)

(21) Appl. No.: 17/420,376

(22) PCT Filed: Jan. 2, 2020
(86) PCT No.: PCT/KR2020/000033

§ 371 Date: Jul. 1, 2021

(30) Foreign Application Priority Data
Jan. 2, 2019 (IN) 201941000172

(51) Int. Cl. G06V 30/413; G06V 30/418; G06V 30/414; G06V 10/26

(52) U.S. Cl. CPC G06V 30/413; G06V 10/26; G06V 30/414; G06V 30/418

(57) ABSTRACT

The disclosure provides a method for document management in a network. The method includes acquiring, by an electronic device, a source document as an image, extracting, by the electronic device, a plurality of multi-modal information from the source document by parsing the source document, automatically determining, by the electronic device, a category of the source document based on a comparison of the extracted plurality of multi-modal information with a plurality of pre-defined features, extracting, by the electronic device, a plurality of data fields corresponding to the determined category from the source document, determining, by the electronic device, a priority for each of the plurality of data fields and storing, by the electronic device, the plurality of data fields in at least one of a secure information source and an unsecure information source based on the determined priority.

### CROSS-REFERENCE TO RELATED APPLICATIONS

This application is a 371 of International Application No. PCT/KR2020/000033 filed on Jan. 2, 2020, which claims priority to India Patent Application No. 201941000172 filed on Jan. 2, 2019, the disclosures of which are herein incorporated by reference in their entirety.

### BACKGROUND

### 1. Field

The disclosure relates to a method and apparatus for document management in a network. More particularly, the disclosure relates to document recognition and provision of contextual and augmented reality services pertaining to the document using machine learning.

### 2. Description of Related Art

Many applications and services pertaining to acquiring documents and filling forms. Most services require forms to be filled with personal information available from a passport, a birth certificate, a residence document, educational transcripts and the like. Services pertaining to booking airline tickets, digital signature of documents, and secure storage of documents require detection of the documents to automatically perform any potentially services related to the documents.

Existing solutions are directed to maintaining separate records for physical document images and digital data. Users are required to manually feed data or categorize to filter important and unimportant documents. There exists a need to automatically categorize documents, extract data from these documents to convert them into structured data and use the structured data to perform actions such as automatically filling forms, avail services related to purchasing of tickets to travel and the like.

The above information is presented as background information only to help the reader to understand the present invention. Applicants have made no determination and make no assertion as to whether any of the above might be applicable as Prior Art with regard to the present application.

An aspect of the present disclosure to provide a method and apparatus for document management in an electronic device.

Another object of the embodiments herein is to provide contextual and augmented reality (AR) based services through the electronic device.

Another object of the embodiments herein is to automatically determine a category of a document image.

Another object of the embodiments herein is to cause to display an AR overlay of a target document using data extracted from a source document. Another object of the embodiments herein is to provide contextual services pertaining to a detected document.

Another object of the embodiments herein is to locate a document in a real location through causing to display an AR object in an immersive environment.

### SUMMARY

Accordingly, embodiments disclosed herein provide a method for document management in a network. The method includes acquiring, by an electronic device, a source document as an image, extracting, by the electronic device, a plurality of multi-modal information from the source document by parsing the source document, automatically determining, by the electronic device, a category of the source document based on a comparison of the extracted plurality of multi-modal information with a plurality of pre-defined features, extracting, by the electronic device, a plurality of data fields corresponding to the determined category from the source document, determining, by the electronic device, a priority for each of the plurality of data fields and storing, by the electronic device, the plurality of data fields in at least one of a secure information source and an unsecure information source based on the determined priority.

In an embodiment, the method further includes acquiring, by the electronic device, a target document as an image, extracting, by the electronic device, a plurality of multi-modal information from the target document by parsing the target document, automatically determining, by the electronic device, a category of the target document based on a comparison of the extracted plurality of multi-modal information with the plurality of pre-defined features, retrieving, by the electronic device, a plurality of data fields corresponding to the determined category from at least one of the secure information source and the unsecure information source, identifying, by the electronic device, a plurality of target data fields in the target document based on the determined category, creating, by the electronic device, an augmented reality (AR) overlay over the target document by positioning the retrieved plurality of data fields corresponding to the identified plurality of target data fields and performing, by the electronic device, at least one of causing to display the target document with the AR overlay, and storing an image of the target document with the AR overlay in one of the secure information source and the unsecure information source.

In an embodiment, the method further includes automatically outputting the predicted candidate data item corresponding to the inputted data item comprises recommending the at least one candidate input to the user, auto-completing the inputted data item using the predicted candidate input and autocorrecting the inputted data item using the predicted candidate input.

In an embodiment, acquiring the target document as an image of includes at least one of scanning, by the electronic device, a physical document using a camera communicably coupled to the electronic device and retrieving, by the electronic device, the target document from a local storage source of the electronic device, retrieving, by the electronic device, the target document from a cloud storage source communicably coupled to the electronic device.

In an embodiment, the method further includes retrieving, by the electronic device, the plurality of data fields based on matching contextual information derived from the plurality of data fields with contextual information pertaining to the electronic device and causing to display, by the electronic device, notifications based on the matched contextual information.

In an embodiment, the contextual information comprises at least one of date, time, location and application usage.

In an embodiment, the method further includes receiving, by the electronic device, location information pertaining to a physical copy of the source document, storing, by the electronic device, the location information in the secure information source, triggering, by the electronic device, a camera communicably coupled to the electronic device upon receiving a selection of the source document for retrieving location, scanning, by the electronic device, a location using the camera, and causing to display, by the electronic device, an AR object indicative of the source document upon successfully matching the scanned location with the stored location information.

In an embodiment, acquiring the source document as an image includes at least one of scanning, by the electronic device, a physical document using a camera communicably coupled to the electronic device, retrieving, by the electronic device, the source document from a local storage source of the electronic device, retrieving, by the electronic device, the source document from a cloud storage source communicably coupled to the electronic device.

In an embodiment, the plurality of multi-modal information comprises at least one of textual information, a quick response (QR) code, a barcode, geographical tag, date, time, identifiers indicative of application usage and images.

In an embodiment, the pre-defined set of features comprise at least one of a name, identifiers indicative of a category of document, date of birth and geographic location.

In an embodiment, automatically determining a category of the source document based on a comparison of the extracted plurality of multi-modal information with a plurality of pre-defined set of features includes transmitting, by the electronic device, the source document and the extracted plurality of multi-modal information to a server communicably coupled to the electronic device, receiving, by the electronic device, results pertaining to optical character recognition performed over the source document from the server, dividing, by the electronic device, the source document into a plurality of regions based on the results pertaining to optical character recognition, matching, by the electronic device, at least one of textual information in each of the plurality of regions and the extracted plurality of multi-modal information with the pre-defined set of features to generate a matching score and automatically categorizing, by the electronic device, the source document based on the generated matching score.

In an embodiment, extracting the plurality of data fields corresponding to the determined category from the source document comprises one of converting the matched textual information to the plurality of data fields, wherein each of the plurality of data fields corresponds to one of the set of pre-defined features and converting manual information pertaining to the source document to the plurality of data fields, wherein each of the plurality of data fields corresponds to one of the set of pre-defined features and wherein the manual information is manually received from a user.

In an embodiment, the secure information source and unsecure information source are at least one of a local storage of the electronic device and a cloud storage communicably coupled to the electronic device.

Accordingly, embodiments disclosed herein provide an electronic device for document management. The electronic device includes an image sensor, an image scanner communicably coupled to the image sensor configured to acquire any of a source document and a target document as an image, a classification engine communicably to the image sensor. The classification engine is configured for extracting a plurality of multi-modal information from the source document by parsing the source document, automatically determining a category of the source document based on a comparison of the extracted plurality of multi-modal information with a plurality of pre-defined features, extracting a plurality of data fields corresponding to the determined category from the source document, determining a priority for each of the plurality of data fields and storing, by the electronic device, the plurality of data fields in at least one of a secure information source and an unsecure information source based on the determined priority.

In an embodiment, the electronic device includes an augmented reality (AR) engine communicably coupled to the image sensor, the image scanner and the classification engine, wherein the AR engine is configured for extracting a plurality of multi-modal information from the target document by parsing the target document, automatically determining a category of the target document based on a comparison of the extracted plurality of multi-modal information with the plurality of pre-defined features, retrieving a plurality of data fields corresponding to the determined category from at least one of the secure information source and the unsecure information source, identifying a plurality of target data fields in the target document based on the determined category, creating an augmented reality (AR) overlay over the target document by positioning the retrieved plurality of data fields corresponding to the identified plurality of target data fields and performing at least one of causing to display the target document with the AR overlay, and storing an image of the target document with the AR overlay in one of the secure information source and the unsecure information source.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Various embodiments of the present disclosure provide to automatically categorize documents, extract data from these documents to convert them into structured data and use the structured data to perform actions such as automatically filling forms, avail services related to purchasing of tickets to travel and the like.

### BRIEF DESCRIPTION OF THE DRAWINGS

This invention is illustrated in the accompanying drawings, throughout which like reference letters indicate corresponding parts in the various figures. The embodiments herein will be better understood from the following description with reference to the drawings, in which:

FIG. 1A is a block diagram illustrating hardware components of an electronic device for document management, according to an embodiment as disclosed herein;

FIG. 1B is a block diagram with application elements, core elements and storage elements pertaining to the electronic device, according to an embodiment as disclosed herein;

FIG. 2 is a flow diagram for generating an AR overlay over a document image, according to an embodiment as disclosed herein;

FIGS. 3A and 3B is a flow diagram illustrating steps for automatically categorizing a source document and extract data fields as structured data from the source document, according to an embodiment as disclosed herein;

FIG. 4 is a flow diagram illustrating steps to cause to display a target document with an AR overlay generated from the structured data, according to an embodiment as disclosed herein;

FIG. 5 illustrates a flow diagram implementing a method for locating a document in AR mode, according to an embodiment as disclosed herein;

FIG. 6 illustrates a flow diagram for a method to automatically categorize a document, according to an embodiment as disclosed herein;

FIGS. 7A and 7B illustrate a flow diagram for a method for category-based prioritization of the document, according to embodiments disclosed herein;

FIGS. 8A and 8B is an example scenario for AR physical form filling, in accordance with embodiments disclosed herein;

FIGS. 9A to 9C is an example scenario for extracting data from a document using optical character recognition, in accordance with embodiments disclosed herein;

FIG. 10 is an example scenario for locating documents based on category and type, in accordance with embodiments disclosed herein;

FIGS. 11A-11E is an example scenario for geotagging documents in secure locations and locating the secure location based on the geo-tag in augmented reality, in accordance with embodiments disclosed herein;

FIGS. 12A and 12B is an example scenario for contextual reminders and availing of contextually relevant services, in accordance with embodiments disclosed herein;

FIG. 13 is a flow diagram 1300 illustrating bill payment using document management features, in accordance with embodiments disclosed herein;

FIGS. 14A-14C is an example scenario for sharing the document using trusted sharing options, in accordance with embodiments disclosed herein;

FIGS. 15A and 15B is an example scenario for transaction management using document management features, in accordance with embodiments disclosed herein;

FIGS. 16A and 16B is an example scenario for contextual reminders, in accordance with embodiments disclosed herein;

FIG. 16C is a flow diagram illustrating a method for providing the contextual reminders in the example scenario in FIGS. 16A and 16B.

While embodiments of the present disclosure are described herein by way of example using several illustrative drawings, those skilled in the art will recognize the present disclosure is not limited to the embodiments or drawings described. It should be understood the drawings and the detailed description thereto are not intended to limit the present disclosure to the form disclosed, but to the contrary, the present disclosure is to cover all modification, equivalents and alternatives falling within the spirit and scope of embodiments of the present disclosure as defined by the appended claims.

### DETAILED DESCRIPTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments. Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein. Further it should be possible to combine the flows specified in different figures to derive a new flow.

As is traditional in the field, embodiments may be described and illustrated in terms of blocks which carry out a described function or functions. These blocks, which may be referred to herein as managers, engines, controllers, units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The embodiments herein and the various features and advantageous details thereof are explained more fully with reference to the non-limiting embodiments that are illustrated in the accompanying drawings and detailed in the following description.

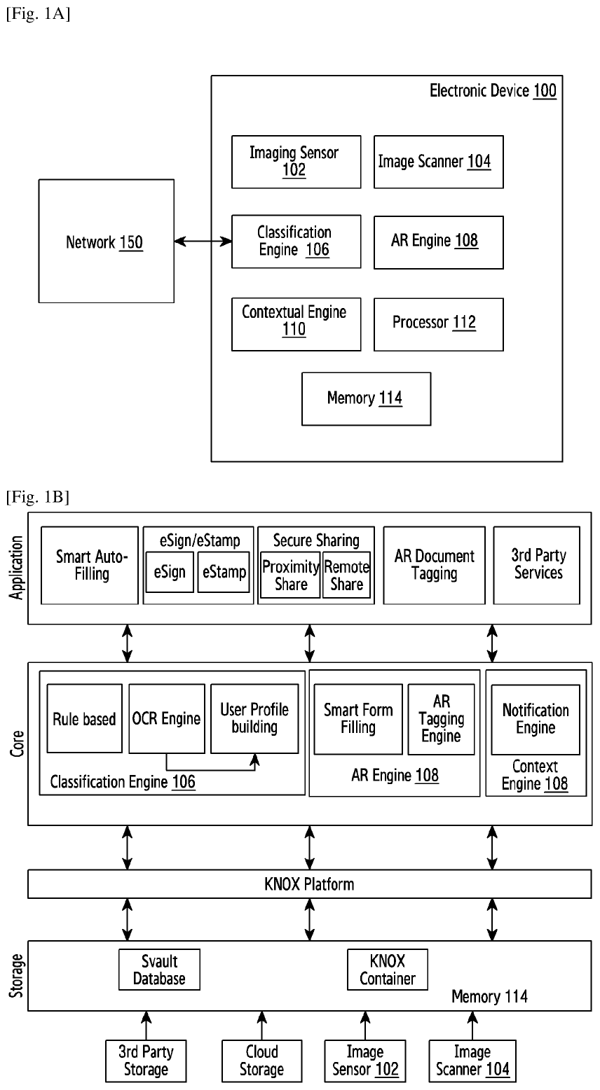

The embodiments disclosed herein can be implemented through at least one software program running on at least one hardware device and performing network management functions to control the elements. The elements shown in FIGS. 1A-15B include blocks which can be at least one of a hardware device, or a combination of hardware device and software module.

In accordance with embodiments disclosed herein, document management involves acquiring any document and then retrieving document properties to map them to a pre-stored set of documents. Depending upon the document category, relevance of data inside document in any form such as text, QR code, etc. can be determined for providing services to the user.

FIG. 1A is a block diagram illustrating hardware components of an electronic device for document management. FIG. 1A is a block diagram of an electronic device 100 with hardware components of an electronic device for asset management, according to an embodiment as disclosed herein. The electronic device 100 includes an imaging sensor 102, an image scanner 104, a classification engine 106, an augmented reality (AR) engine 108, a contextual engine 110, a processor 112 and a memory 114.

In some embodiments, the electronic device 100 can include communication units pertaining to communication with remote computers, servers or remote databases over a communication network. The communication network can include a data network such as, but not restricted to, the Internet, local area network (LAN), wide area network (WAN), metropolitan area network (MAN) etc. In certain embodiments, the communication network can include a wireless network, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS) etc.

The processor 112 can be, but not restricted to, a Central Processing Unit (CPU), a microprocessor, or a microcontroller. The processor 1112 executes sets of instructions stored on the memory 114.

The memory 114 includes storage locations to be addressable through the processor 112. The memory 1114 is not limited to a volatile memory and/or a non-volatile memory. Further, the memory 114 can include one or more computer-readable storage media. The memory 114 can include non-volatile storage elements. For example non-volatile storage elements can include magnetic hard discs, optical discs, floppy discs, flash memories, or forms of electrically programmable memories (EPROM) or electrically erasable and programmable (EEPROM) memories.

In some embodiments, the memory 114 is coupled to an immersive environment library. The immersive environment library is a source for multi-modal content used for extracting information indicative of various immersive environments. Immersive environments include augmented reality (AR) environments, virtual reality (VR) environments, mixed reality environments and the like. The immersive environment library can be but not limited to a relational database, a navigational database, a cloud database, an in-memory database, a distributed database and the like. In some embodiments, the immersive environment library can be stored on the memory 114. In some other embodiments, the immersive environment library is stored on a remote computer, a server, a network of computers or the Internet.

In some embodiments, the memory 114 is communicably coupled to third party storage, cloud storage and the like.

The image sensor 102 captures still images or moving images of the real world environment pointed at by a camera (not shown) placed on the electronic device 100. The camera is communicably coupled to the imaging sensor 102. The image sensor 102 captures an image of a document pointed at by a user of the electronic device 100. The image scanner 104 in conjunction with the image sensor 102 scans documents to generate images of the documents. The generated images are further converted to documents of types including but not limited to word documents, portable document formats, image formats and the like.

FIG. 1B is a block diagram with application elements, core elements and storage elements pertaining to the electronic device 100, according to an embodiment as disclosed herein. Documents can be acquired from third party cloud storage services or from the memory 114. Further, documents can be scanned and stored using the image sensor 102 and the image scanner 104. At a core level, acquired documents are filtered for text content and passed to the classification engine 106. Scanned documents are input to OCR modules and text extraction is done. Successfully classified documents and their metadata is stored in the memory 114 or in a remote database such as the Knox database. Information from the database is used to build user profile which is further used for filling forms. The context engine 108 engine seamlessly provides the documents and details of the documents required by the user based on either location the user is in or the context of activity the user is performing. The AR engine 108 takes care of locating the already marked items or documents kept indoors in a camera preview. At a utility level, individual operations pertaining to a specific document can be performed by the electronic device 100.

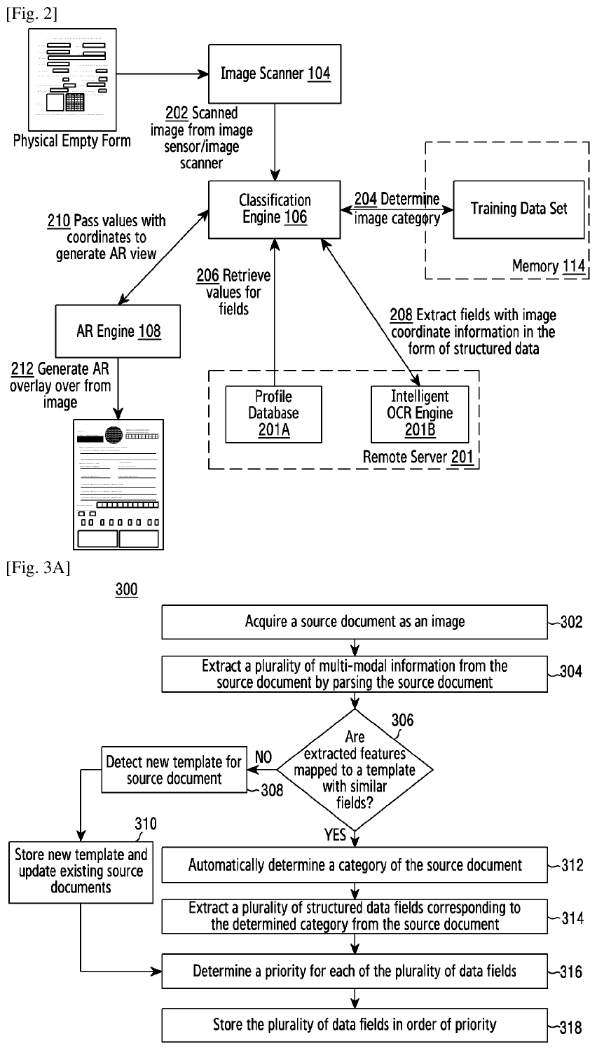

FIG. 2 is a flow diagram for generating an AR overlay over a document image, according to an embodiment as disclosed herein. At step 202, any physical form document is scanned using the image sensor 102 and the image scanner 104. The classification engine 106 classifies the image preview as a form based on a training data set stored on the memory 114. Based on the image category, fields with image coordinate information is extracted in the form of structured data. Then, at step 206, the system can retrieve fields mentioned inside the form such as name, date of birth, address etc. and correspondingly retrieve those information from a profile database 201A. Additionally, at step 208, fields are also retrieved through parsing the document image using an intelligent optical character recognition (OCR) engine 201B. In an embodiment, the profile database 201A and the intelligent OCR engine 201B is included in a remote server 201 communicably coupled to the electronic device 100. The retrieved information can be overlaid as an AR object over a form using the AR engine 108 at step 212.

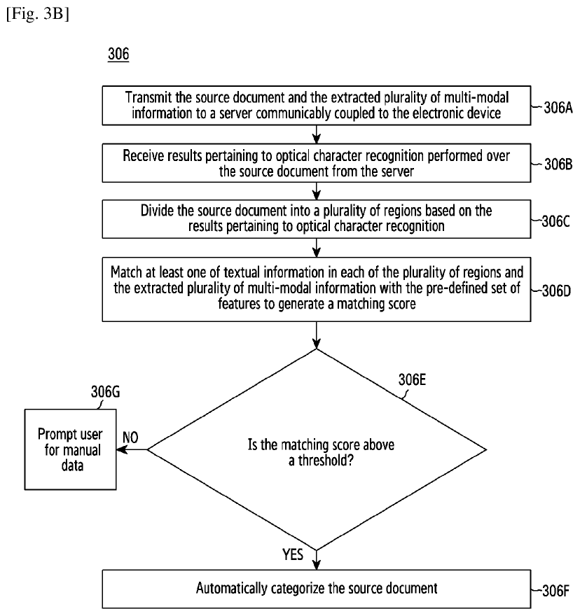

FIGS. 3A and 3B are flow diagrams illustrating steps for automatically categorizing a source document and extract data fields as structured data from the source document, according to an embodiment as disclosed herein. At step 302, the image sensor 102 and the image scanner 104 acquires a source document as an image.

After scanning the file or image, the components of the source document including text, text regions, QR code, Barcode, Logo, etc. are extracted at step 304. The components are accumulated and matched with the templates present in the memory 114 and/or in remote storage communicably coupled to the memory 114 at step 306. The template matching helps in classification of document which further categorizes the contents in meaningful structured data. This structured data is stored in the remote server 201 to build the profile of the user at steps 312 and 314.

In the above process, if the components are not matched with any of the templates of existing models then the document is detected to be a new template and stored at steps 308 and 310.

FIG. 3B illustrates steps to automatically categorize a new document. At step 306A and 306B, a plurality of multi-modal information such as but not limited to text, text regions, QR codes, barcode, logo are extracted from the document. At step 306C, the text based on the text region, text size or text style is prioritized. As observed in most of the document, the texts at the top, i.e. titles, are prominent source to classify the document. So while dividing the document in the text regions, more weightage is given to the texts in region towards the top of the document. In case the text region detected is big enough, then the region itself is divided into a plurality of sub regions and text in each of the sub regions is given weightage proportionally according to its alignment from the top of the parent region. Now the contents or text is accumulated and their sum is evaluated against the threshold value to classify it as a particular document. Let the probability of the classifying a document at this stage be P(A). As a next step, weightage is given to the combination of texts or words present in the content which makes meaningful sense. For example, combinations of words having Country Code, Passport No. and Nationality are given extra weightage as they can probably be fields of a passport and used to classify a document as passport. Similarly combinations of words like name of country, Driving License, an eleven digit code should be given more weightage as they can be used to classify a document as a Driving License. The weightage of all the possible combinations of texts is accumulated and evaluated against the threshold value to classify it as a particular document. Let the probability of the classifying a document at this stage be P(B).

So the conditional probability of classification of a document using Bayes' theorem can be stated as:

P(A|B)=(P(B|A)P(A))/(P(B))

Where P(B/A) is the probability of evidence given that our hypothesis is true. When the document is classified, the new template is saved and the training set is updated for reference. The new contents are mapped to the existing templates and convert data to structured form.

If the content contains a QR code or a barcode, the OCR engine 201B decodes it to text and compares it with the structured data to verify the validity of the information and make correction in the data which can occur because of wear and tear of the document or noise in the system to capture the information. Once the structured data is saved, context based prioritization of fields can be applied to the document.

In some embodiments, the auto categorization of the source document or a target document begins by acquiring a file using the image sensor 102 and the image scanner 104 or reading file from a file system/mailbox or any other source. The file is processed by the classification engine 106 to detect if the file qualifies as document or not. The file is then processed for specific features such as presence of text, QR code, barcode or logo. The file along with the extracted features is then sent to cloud for categorization where first the OCR is performed over the document.

As shown in FIG. 3B, at step based on the results of OCR, the document is divided into blocks where each block is matched to a predefined set of features to generate a matching score (step 306D). This score for all blocks is used to define an overall similarity. If there is a similar document already present in a pre-defined set, it is used as a reference to convert text into structured data. If there is no similar document, the user is prompted to separate fields from values which can be added to the pre-defined set for future classification (step 306G). If the matching score is above a threshold, the classification engine 106 is directed to automatically categorize the source document.

In some embodiments, based on the category of the document, the source document is moved to a secure location such as Knox storage or the user can be given an option to format the important information such as ID number in the image file stored at non-secure location. The information from the document will be saved with a profile which can be used in future to auto-fill forms. Priority of any field inside the given document can be decided on the following basis:

Pre-defined Set: Based on the category of document, a pre-defined set of fields inside that document is considered to be of higher priority.

Stored Data: If the current document contains any information already in the device database and belongs to a secure category the priority of that field is increased.

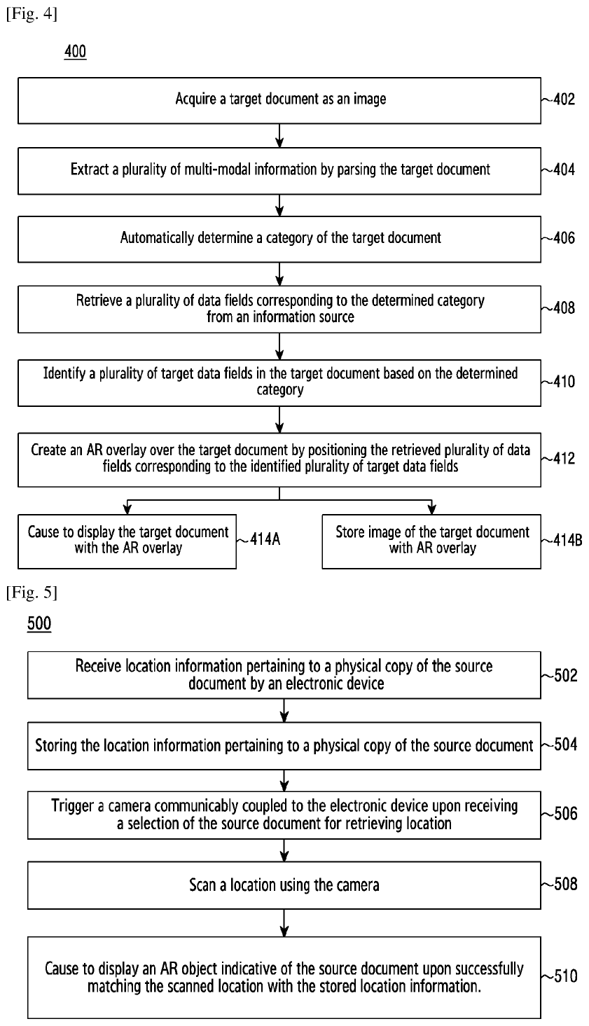

FIG. 4 is a flow diagram illustrating steps to cause to display a target document with an AR overlay generated from the structured data, according to an embodiment as disclosed herein.

It is a common user behavior to store physical documents at specific physical locations which is convenient for a user but in digital world such as smartphone, it becomes difficult to map those document files. This leads to extra effort in terms of remembering locations of all files. The invention addresses these problems by providing AR based locating document as well as easy retrieval of information from stored documents in AR view itself. The user can scan any physical form document using camera where the AR unit will classify the image preview as a form based on image classification. Then, the electronic device 100 can retrieve fields mentioned inside the form such as Name, Date of Birth, Address etc. and correspondingly retrieve those information from the user profile. These information can be previewed over the camera image of a target document.

At step 402, a target document is acquired as an image. The target document can be acquired through scanning a form by the image sensor 102 and the image scanner 104 or be retrieved from the memory 114 or any storage medium communicably coupled to the memory 114. At step 404, a plurality of multi-modal information is extracted from the target document by the classification engine 106. Steps similar to automatically categorizing the source document (shown in FIGS. 3A and 3B) are performed to automatically categorize the target document. Upon automatically categorizing the target document, a plurality of target data fields corresponding to the determined category are retrieved. The target data fields are mapped to a corresponding plurality of data fields on the target document at step 410. An AR overlay with retrieved plurality of data fields corresponding to the identified plurality of target data fields is created by the AR engine 108 at step 412. The AR overlay can be caused to be displayed on a display screen of the electronic device 100 or be stored in the memory 114 based on a user choice at steps 414A and 414B.

FIG. 5 illustrates a flow diagram implementing a method for locating a document in AR mode, according to an embodiment as disclosed herein. The electronic device 100 can map a document to a physical location initially in the AR mode. The AR engine 108 combines the location details with the document details to allow a user to view or search documents kept at that location in future. At step 502, location information pertaining to a physical copy of the source document is received by the AR engine 108. The location information is stored in the memory 114 at step 504. The image sensor 102 is triggered by the AR engine 108 upon receiving a user selection of the source document for retrieving the location of the source document. The image sensor 102 is used to scan a real location. Upon mapping the scanned location with the stored location information pertaining to the chosen source document at step 510, the AR engine 108 causes to display an AR object indicative of the source document on a display screen of the electronic device 100.

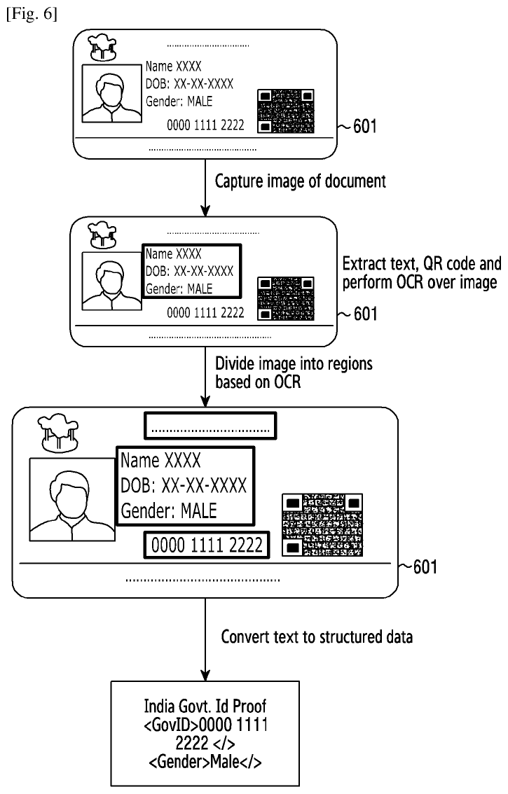

FIG. 6 illustrates a flow diagram for a method to automatically categorize a document, according to an embodiment as disclosed herein. As shown, the image sensor 102 captures the source document 601. Text, Quick Response (QR) code and the like are extracted from the document 601 and OCR is performed over the image of the document 601. Text identified from the OCR is converted into structured data as shown. The structured data is stored in the memory 114 or a more secure location such as Knox. The structured data can be used for AR form filling and contextual actions pertaining to the document 601.

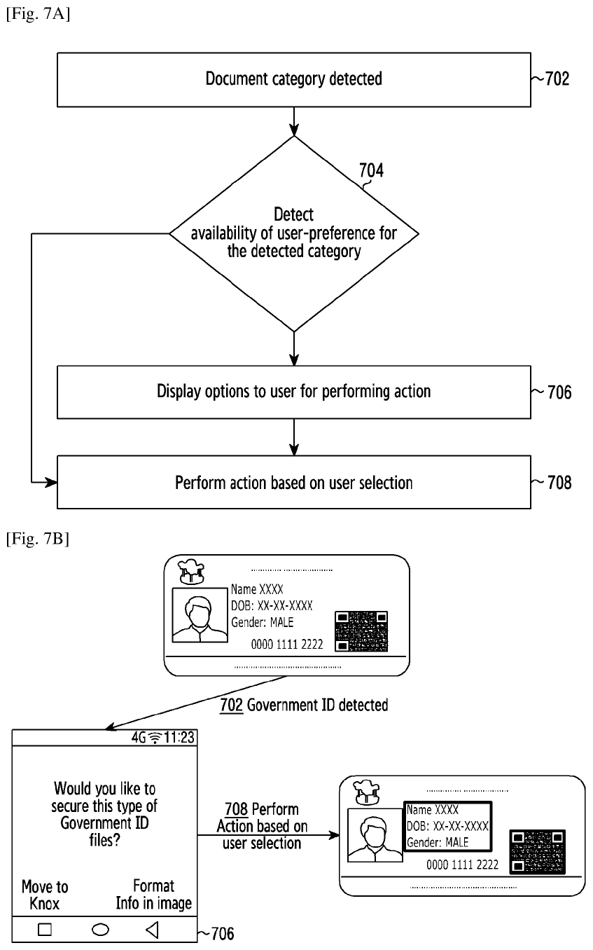

FIGS. 7A and 7B illustrate a flow diagram for a method for category-based prioritization of the document, according to embodiments disclosed herein. At step 702, the category of the document is detected by the classification engine 106. Based on the category of document, the image or file is moved to a secure location such as Knox storage or the user can be given an option to format the important information such as ID number in the image file stored at non-secure location (steps 704, 706 and 708). The information from the document is saved with a profile which can be used in future to auto-fill forms.

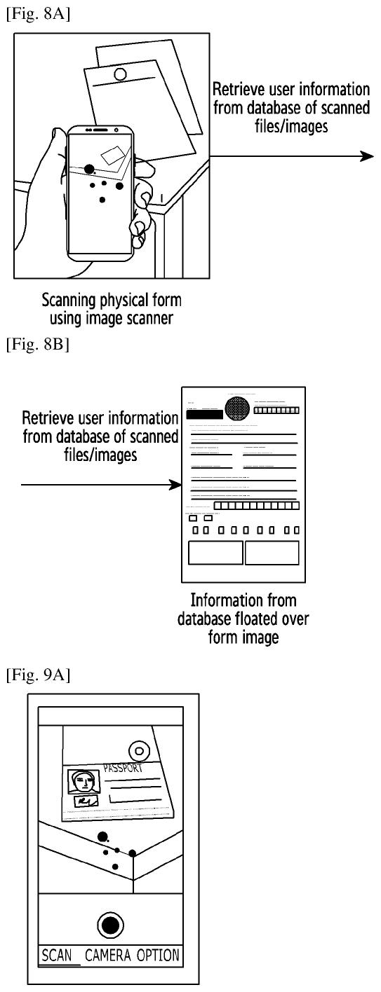

FIGS. 8A and 8B is an example scenario for AR physical form filling, in accordance with embodiments disclosed herein.

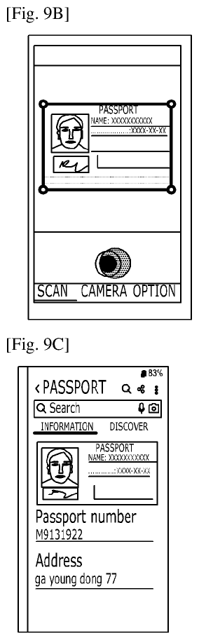

FIGS. 9A to 9C is an example scenario for extracting data from a document using optical character recognition, in accordance with embodiments disclosed herein.

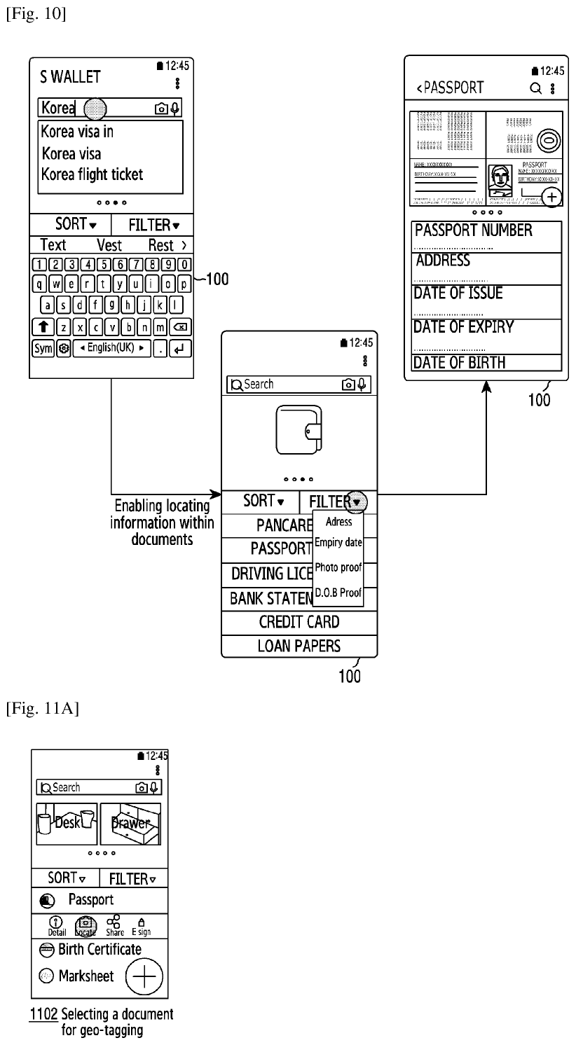

FIG. 10 is an example scenario for locating documents based on category and type, in accordance with embodiments disclosed herein.

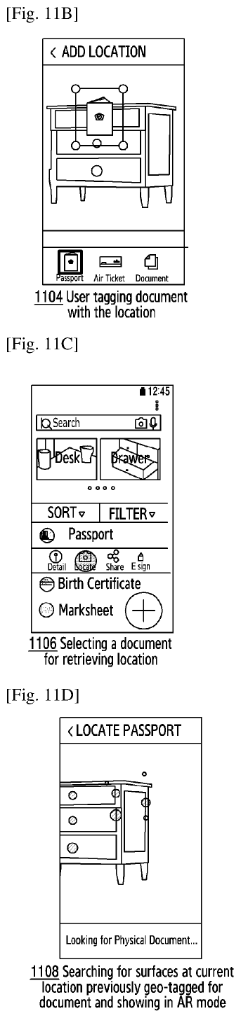

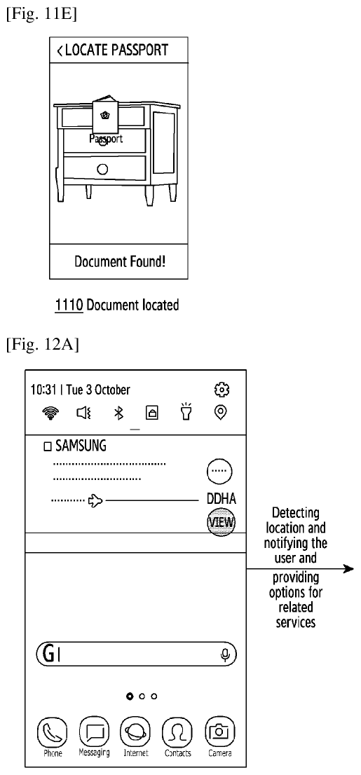

FIGS. 11A-11E is an example scenario for geotagging documents in secure locations and locating the secure location based on the geo-tag in augmented reality, in accordance with embodiments disclosed herein. At step 1102, the user selects a document for geo-tagging. At step 1104, the AR engine 108 in conjunction with the image sensor 102 tags the document with the location information. At step 1106, the user selects a document to retrieve the location. At step 1108, the image sensor 102 scans for surfaces at a current location previously geo-tagged for the document and showing in AR mode. At step 1110, the AR engine 108 locates the document upon successfully matching the location scanned by the image sensor 102 with the location information. An AR object is caused to display on the electronic device 100 as shown.

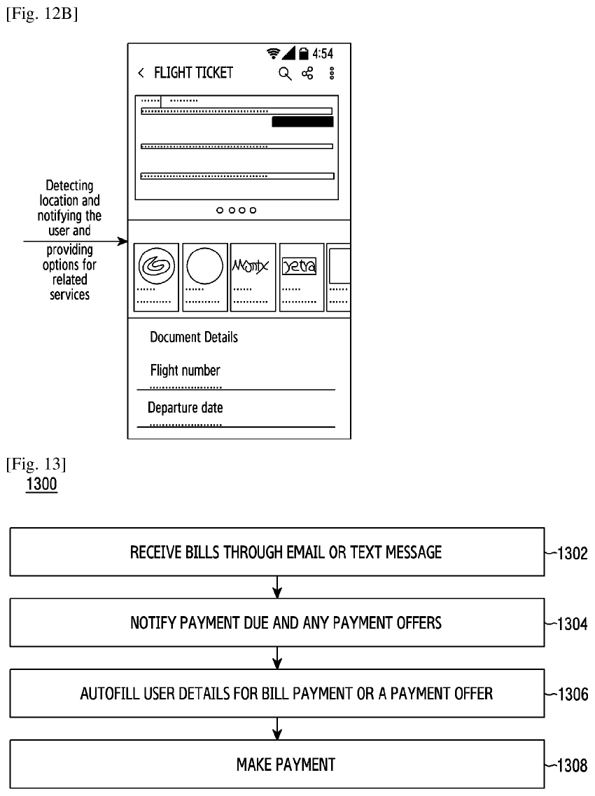

FIGS. 12A and 12B is an example scenario for contextual reminders and availing of contextually relevant services, in accordance with embodiments disclosed herein.

FIG. 13 is a flow diagram 1300 illustrating bill payment using document management features, in accordance with embodiments disclosed herein. At step 1302, the contextual engine 110 detects bills received through email or text messages. In an embodiment, bills can be scanned from corresponding physical copies by the image scanner 104. Accordingly, base information extracted from the bills, the user is notified of any due dates pertaining to the bills at step 1304. At step 1306, the user provides a confirmation to pay the bills and accordingly, user information stored as structured data in the memory 114 is used to auto fill any forms for bill payment. Further, any financial information such as debit card/credit card information or bank account is further used to automatically make the payment due at step 1308.

In an embodiment, the user can place preset actions to be performed by the contextual engine 110 to perform any actions related to bill payment. For example, the user can opt to direct the contextual engine 110 to automatically pay any bill detected two days before the due date.

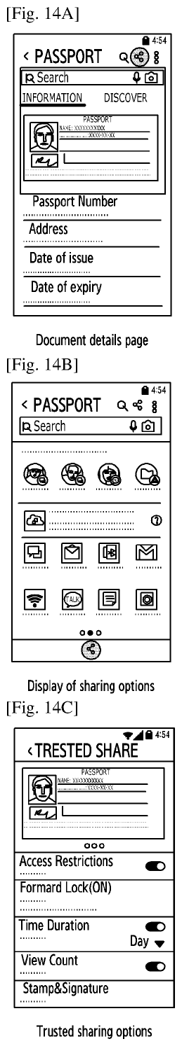

FIGS. 14A-14C is an example scenario for sharing the document using trusted sharing options, in accordance with embodiments disclosed herein.

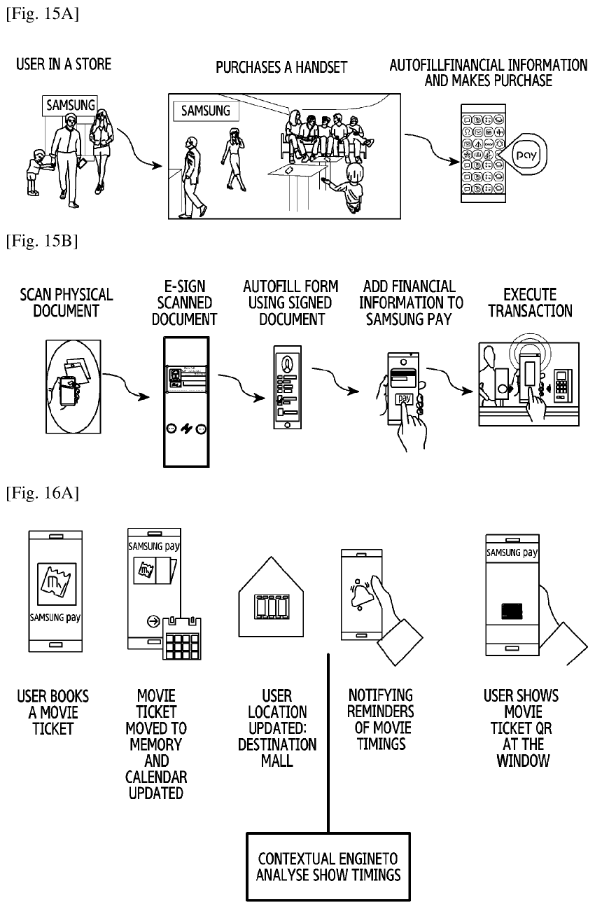

FIGS. 15A and 15B is an example scenario for transaction management using document management features, in accordance with embodiments disclosed herein. The contextual engine 110 (shown in FIG. 1) through third party services, provides offers for items at a store when it is detected that the user with the electronic device 100 is at the store through location information. Accordingly, to purchase an item, information pertaining to identity or financial information is needed. Using the methods disclosed in conjunction with FIGS. 2-7, information can be extracted from documents scanned from a physical copy or from documents stored in the memory 114 or in a secure location such as Knox. The information is stored as structured data and is used to automatically fill forms related to the purchase. In an embodiment, prior to automatically filling target documents, the user can be prompted to electronically sign the source document. Further, financial information can be extracted from any cards or bank information stored in the memory 114 or in a secure location communicably coupled to the memory 114. The extracted financial information is automatically used to complete the purchase.

In an example, forms for credit card application can be automatically filled using extracted information. The target forms are automatically filled and any e-KYC (Know Your Customer) procedures can be completed using the extracted information.

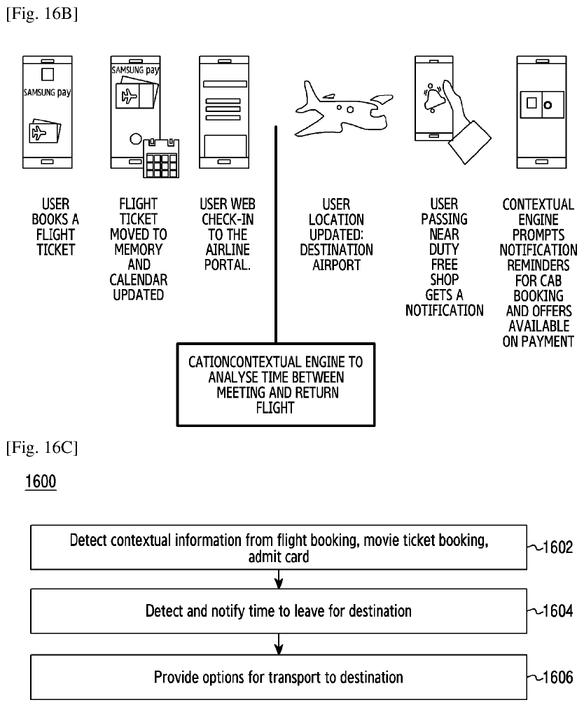

FIGS. 16A and 16B is an example scenario for contextual reminders, in accordance with embodiments disclosed herein. In an example, a user books flight tickets or movie tickets. The flight ticket is accordingly stored in the memory 114 or if a secure option is chosen in the Knox database. The contextual engine 110 receives location information pertaining to the location of the user holding electronic device 100 and accordingly provides notification of movie timings or flight timings. In an example, when the user checks-in to an airline portal for a boarding pass, the contextual engine 110 provides notification reminders for cab booking at an appropriate time such that the user can reach the airport in time. In a further example, the contextual engine 110 provides options for cab rides to a destination corresponding to the bookings stored based on the timing determined from the booked tickets or boarding pass. In an embodiment, the contextual engine 110 provides offers available for cab rides and convenient payment options for the same.

FIG. 16C illustrates a flow diagram 1600 for automatically providing transport options to a destination using contextual information from data extracted from documents of the user. A user books tickets for travel or tickets for a movie and receives tickets in email or by text message. In an embodiment, the user can use the image scanner 104 to scan a ticket. At step 1602 Information from the ticket is extracted by the steps illustrated in FIGS. 2, 3A, 3B and 4. Accordingly, at step 1604, the contextual engine 110 provides notifications to the user with regard to the booking. Notifications can pertain to but not limited to reminders of a timing of an event described in the ticket, flight changes in case of a flight booking and the like. At step 1606, the contextual engine 110 provides further options pertaining to transport options to a destination such as an airport, a theatre or a place where an event corresponding to the books is taking place. In some embodiments, the contextual engine 110 can book a cab through a third party application or service at a preset time before the timing extracted from the ticket. For example, transport options such as cab booking can be automatically booked at three hours before a flight such that the user reaches the airport two hours earlier than the flight departure. In furtherance to this example, the contextual engine 110 can also provide updated notifications for the flight based on information from the airlines website through the Internet.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method performed by an electronic device (100) for document management, the method comprising:
acquiring a source document as an image;
extracting a plurality of multi-modal information from the source document by parsing the source document;
automatically determining a category of the source document based on a comparison of the extracted plurality of multi-modal information with a plurality of pre-defined features;
extracting a plurality of data fields corresponding to the determined category from the source document;
determining a priority for each of the plurality of data fields; and
storing the plurality of data fields in at least one of a secure information source and an unsecure information source based on the determined priority.

2. The method of claim 1, further comprising:
acquiring a target document as an image;
extracting a plurality of multi-modal information from the target document by parsing the target document;
automatically determining a category of the target document based on a comparison of the extracted plurality of multi-modal information with the plurality of pre-defined features;
retrieving a plurality of data fields corresponding to the determined category from at least one of the secure information source and the unsecure information source;
identifying a plurality of target data fields in the target document based on the determined category;
creating an augmented reality (AR) overlay over the target document by positioning the retrieved plurality of data fields corresponding to the identified plurality of target data fields; and
performing at least one of causing to display the target document with the AR overlay, and storing an image of the target document with the AR overlay in one of the secure information source and the unsecure information source.

3. The method of claim 1, further comprising:
retrieving the plurality of data fields based on matching contextual information derived from the plurality of data fields with contextual information pertaining to the electronic device (100); and
causing to display notifications based on the matched contextual information.

4. The method of claim 1, further comprising:
receiving location information pertaining to a physical copy of the source document;
storing the location information in the secure information source;
triggering a camera communicably coupled to the electronic device (100) upon receiving a selection of the source document for retrieving location;
scanning a location using the camera;
causing to display an AR object indicative of the source document upon successfully matching the scanned location with the stored location information.

5. The method of claim 1, wherein acquiring the source document as an image comprises at least one of:
scanning a physical document using a camera communicably coupled to the electronic device (100);
retrieving the source document from a local storage source of the electronic device (100);
retrieving the source document from a cloud storage source communicably coupled to the electronic device (100).

6. The method of claim 1, wherein the plurality of multi-modal information comprises at least one of textual information, a quick response (QR) code, a barcode, geographical tag, date, time, identifiers indicative of application usage and images.

7. The method of claim 1, wherein the pre-defined set of features comprise at least one of a name, identifiers indicative of a category of document, date of birth and geographic location.

8. The method of claim 1, wherein automatically determining a category of the source document based on a comparison of the extracted plurality of multi-modal information with a plurality of pre-defined set of features comprises:
transmitting the source document and the extracted plurality of multi-modal information to a server communicably coupled to the electronic device (100);
receiving results pertaining to optical character recognition performed over the source document from the server;
dividing the source document into a plurality of regions based on the results pertaining to optical character recognition;
matching at least one of textual information in each of the plurality of regions and the extracted plurality of multi-modal information with the pre-defined set of features to generate a matching score; and
automatically categorizing the source document based on the generated matching score.

9. An electronic device (100) for document management, the electronic device (100) comprising:
an image sensor (102);
an image scanner (104) communicably coupled to the image sensor (102) configured to acquire any of a source document and a target document as an image;
a classification engine (106) communicably to the image sensor (102), the classification engine (106) configured for:
extracting a plurality of multi-modal information from the source document by parsing the source document;
automatically determining a category of the source document based on a comparison of the extracted plurality of multi-modal information with a plurality of pre-defined features;
extracting a plurality of data fields corresponding to the determined category from the source document;
determining a priority for each of the plurality of data fields; and
storing the plurality of data fields in at least one of a secure information source and an unsecure information source based on the determined priority.

10. The electronic device (100) of claim 9, further comprising an augmented reality (AR) engine (108) communicably coupled to the image sensor (102), the image scanner (104) and the classification engine (106), wherein the AR engine (108) is configured for:
extracting a plurality of multi-modal information from the target document by parsing the target document;
automatically determining a category of the target document based on a comparison of the extracted plurality of multi-modal information with the plurality of pre-defined features;
retrieving a plurality of data fields corresponding to the determined category from at least one of the secure information source and the unsecure information source;
identifying a plurality of target data fields in the target document based on the determined category;
creating an augmented reality (AR) overlay over the target document by positioning the retrieved plurality of data fields corresponding to the identified plurality of target data fields; and
performing at least one of causing to display the target document with the AR overlay, and storing an image of the target document with the AR overlay in one of the secure information source and the unsecure information source.

11. The electronic device (100) of claim 9, wherein acquiring any of the source document and the target document as an image comprises at least one of:
scanning a physical document using the image sensor (102);
retrieving any of the source document and the target document from a local storage source of the electronic device (100);
retrieving any of the source document and the target document from a cloud storage source communicably coupled to the electronic device (100).

12. The electronic device (100) of claim 9, further comprising a contextual engine communicably coupled to the image sensor (102), the image scanner (104), the AR engine (108) and the classification engine (106) configured for:
retrieving the plurality of data fields based on matching contextual information derived from the plurality of data fields with contextual information pertaining to the electronic device (100); and
providing notifications based on the matched contextual information.

13. The electronic device (100) of claim 9, wherein the plurality of multi-modal information comprises at least one of textual information, a quick response (QR) code, a barcode, geographical tag, date, time, identifiers indicative of application usage and images.

14. The electronic device (100) of claim 9, wherein the pre-defined set of features comprise at least one of a name, identifiers indicative of a category of document, date of birth and geographic location.

15. The electronic device (100) of claim 9, wherein automatically determining a category of the source document based on a comparison of the extracted plurality of multi-modal information with a plurality of pre-defined set of features comprises:
transmitting, by the electronic device (100), the source document and the extracted plurality of multi-modal information to a server communicably coupled to the electronic device (100);
receiving, by the electronic device (100), results pertaining to optical character recognition performed over the source document from the server;
dividing, by the electronic device (100), the source document into a plurality of regions based on the results pertaining to optical character recognition;
matching, by the electronic device (100), at least one of textual information in each of the plurality of regions and the extracted plurality of multi-modal information with the pre-defined set of features to generate a matching score; and
automatically categorizing, by the electronic device (100), the source document based on the generated matching score.
